(19) United States
(12) Patent Application Publication
(10) Pub. No.: US 2013/0283233 A1
(43) Pub. Date: Oct. 24, 2013

(54) MULTI-ENGINE EXECUTABLE DATA-FLOW EDITOR AND TRANSLATOR

(71) Applicants: Maria Guadalupe Castellanos, Sunnyvale, CA (US); Cornelio Iñigo, Hermosillo (MX); Carlos Alberto Ceja Limon, Guadalajara (MX); Maria Guadalupe Paz, Hermosillo (MX); Umeshwar Dayal, Saratoga, CA (US)

(72) Inventors: Maria Guadalupe Castellanos, Sunnyvale, CA (US); Cornelio Iñigo, Hermosillo (MX); Carlos Alberto Ceja Limon, Guadalajara (MX); Maria Guadalupe Paz, Hermosillo (MX); Umeshwar Dayal, Saratoga, CA (US)

(21) Appl. No.: 13/454,420

(22) Filed: Apr. 24, 2012

(51) Int. Cl. G06F 9/44

(52) U.S. Cl. 717/113

(57) ABSTRACT

A system, and a corresponding method, that allow a programmer to create and edit a data-flow employing multiple execution engines are provided. The system includes a data-flow editor and a data-flow translator. The method includes providing an illustration of the data-flow and metadata associated with the data-flow on a graphical user interface; representing the data-flow and the metadata by a first code language; dividing the data-flow illustrated on the graphical user interface into fragments; and translating the first code language into the execution code language of the execution engine corresponding to each of the fragments. Each of the fragments are executable on different execution engines and each of the different execution engines are supported by a different execution code language

### BACKGROUND

Data processing applications oftentimes include data-flows using various different technologies. These data-flows require multiple execution engines, each having a different execution code language, to execute the entire data-flow. Creating these complex data-flows is a cumbersome task for a programmer, who typically creates each section of the data-flow independently, stitches the independent sections together in ad-hoc ways, and then conforms the independent sections to one another.

### DESCRIPTION OF THE DRAWINGS

The detailed description will refer to the following drawings in which like numbers refer to like objects, and in which:

FIG. 1 illustrates an embodiment of a system for providing a data-flow, including a data-flow editor, a data-flow translator, and multiple execution engines;

FIG. 2 is a flow chart illustrating an embodiment of a method for creating a data-flow, wherein the method is capable of execution on the system of FIG. 1;

FIG. 3 illustrates another embodiment of a system for providing a data-flow;

FIG. 4 illustrates an exemplary graphical user interface (GUI) including a toolbar;

FIG. 5 is an enlarged illustration of the toolbar of FIG. 4;

FIG. 6 is a flow chart illustrating yet another embodiment of a method for creating a data-flow;

FIG. 7 illustrates an example of a graphical representation of a data-flow and a prompt displayed on a graphical user interface;

FIG. 8 illustrates an example of a first code language;

FIG. 9 is a flow-chart illustrating another embodiment of a method of providing the data-flow;

FIG. 10 is a flow-chart illustrating another embodiment of a method of providing a data-flow; and

FIG. 11 is a flow chart illustrating yet another embodiment of a method for creating a data-flow and its multi-engine execution code.

### DETAILED DESCRIPTION

Disclosed herein is a system and method for creating a data-flow that is executed using multiple execution engines. “Creating” implies editing the data-flow and generating the execution code for the various engines where the different segments of the data-flow will be executed. The system and method is implemented on a suitable programmed device, such as a computer. The data-flow may be created or edited under a single environment and therefore is more efficient and convenient for a programmer or end user. The data-flow includes nodes representing data stores and operators, and arcs representing connections between the data stores and the operators for processing data. In one embodiment, the system includes a data-flow editor and a data-flow translator.

In one embodiment, the data-flow editor includes a graphical user interface (GUI) to edit and display the data-flow and metadata associated with the data-flow. A programmer or end user uses the GUI to edit the data-flow. The data-flow editor also includes a processor that creates an internal in-memory representation of a data-flow edited by the user and produces the execution code for its different fragments. Each fragment is executed on a different execution engine, the execution engines are identified by a user, and each of the execution engines are instructed by a different execution code language. The processor of the data-flow editor includes a compiler that takes as input the in-memory representation (i.e., data structures) of the data-flow and provides a first code language representing the data-flow and its fragments and the metadata associated with the data-flow. The metadata includes the execution engine identified by the user for each of the fragments and metadata associated to the nodes and arcs. The data-flow translator translates the first code language into the execution code language instructing the corresponding execution engine for each of the fragments.

In another embodiment, a data-flow is created or edited by a process that includes displaying a data-flow and metadata associated with the data-flow on a graphical user interface. The process next includes representing the data-flow and the metadata by a first code language and dividing the data-flow illustrated on the graphical user interface into fragments. Each of the fragments are executable on different execution engines and each of the different execution engines are supported by a different execution code language. The process further includes translating the first code language into the execution code language of the execution engine corresponding to each of the fragments.

In yet another embodiment, a computer readable medium stores instructions for performing a method that provides a data-flow employing multiple execution engines for execution. The method may be implemented on a computer. The method includes prompting a user to provide a data-flow including data stores, operators, and connections between the data stores and operators by adding nodes representing the data stores and the operators to a graphical user interface (GUI) and by adding arcs between the nodes representing connections between the corresponding data stores and operators to the GUI; and prompting the user to identify the nodes on the GUI which represent the data stores and the operators executable by the same execution engine. The method also includes grouping the identified nodes executable by the same execution engine into a fragment; representing each of the fragments by a first code language; and independently translating the first code language of each fragment into an execution code language that instructs the corresponding execution engine.

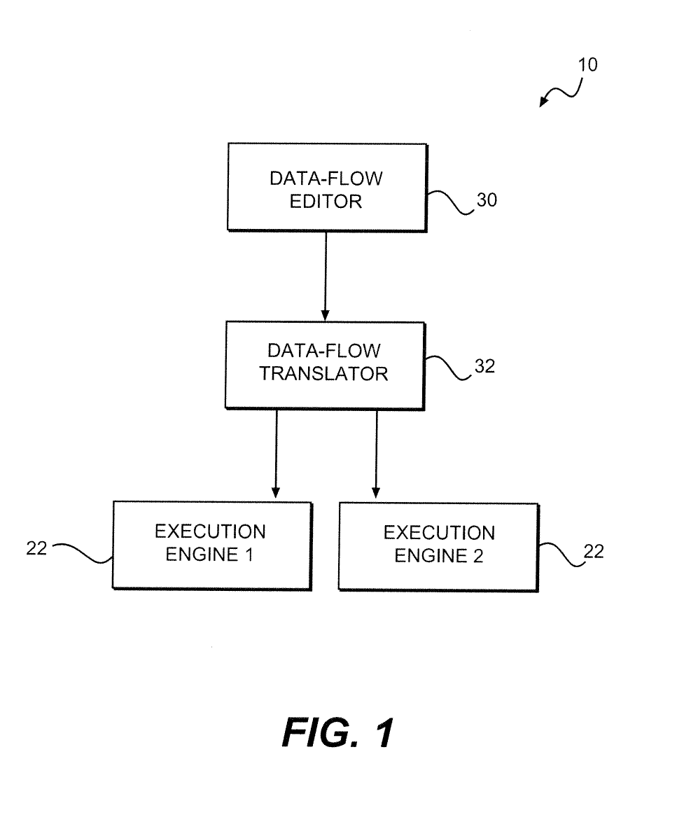

FIG. 1 illustrates an exemplary system 10 that creates or edits a data-flow including a data-flow editor 30, a data-flow translator 32, and execution engines 22 that execute the data-flow.

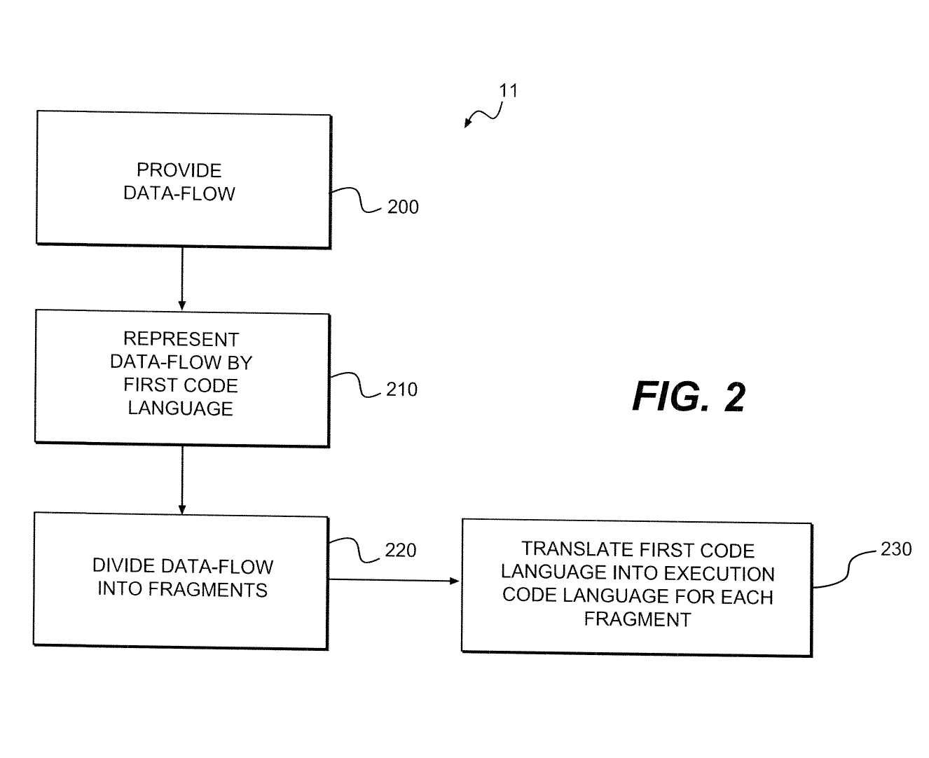

FIG. 2 illustrates an exemplary process 11 implemented by the system 10 of FIG. 1. The process 11 includes providing a data-flow (block 200), representing the data-flow by a first code language (block 210), dividing the data-flow into fragments (block 220), and translating the first code language into execution code language for each of the fragments (block 230).

Block 200 of FIG. 2 typically includes providing an illustration of data stores, operators, and connections of the data-flow and metadata associated with the data-flow on a graphical user interface. After the data-flow and metadata is represented by the first code language (block 210), the process 11 next includes dividing the data-flow illustrated on the graphical user interface into the fragments (block 220). Each of the fragments are executable on different execution engines and each of the different execution engines are supported by a different execution code language. Block 230 includes translating the first code language into the execution code language of the execution engine corresponding to each of the fragments.

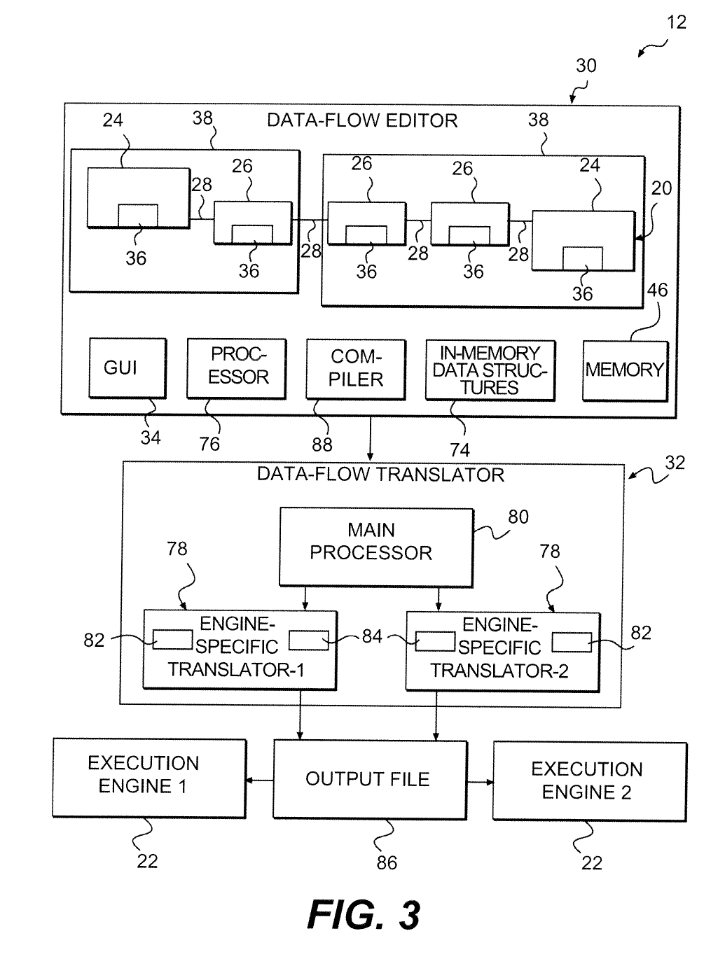

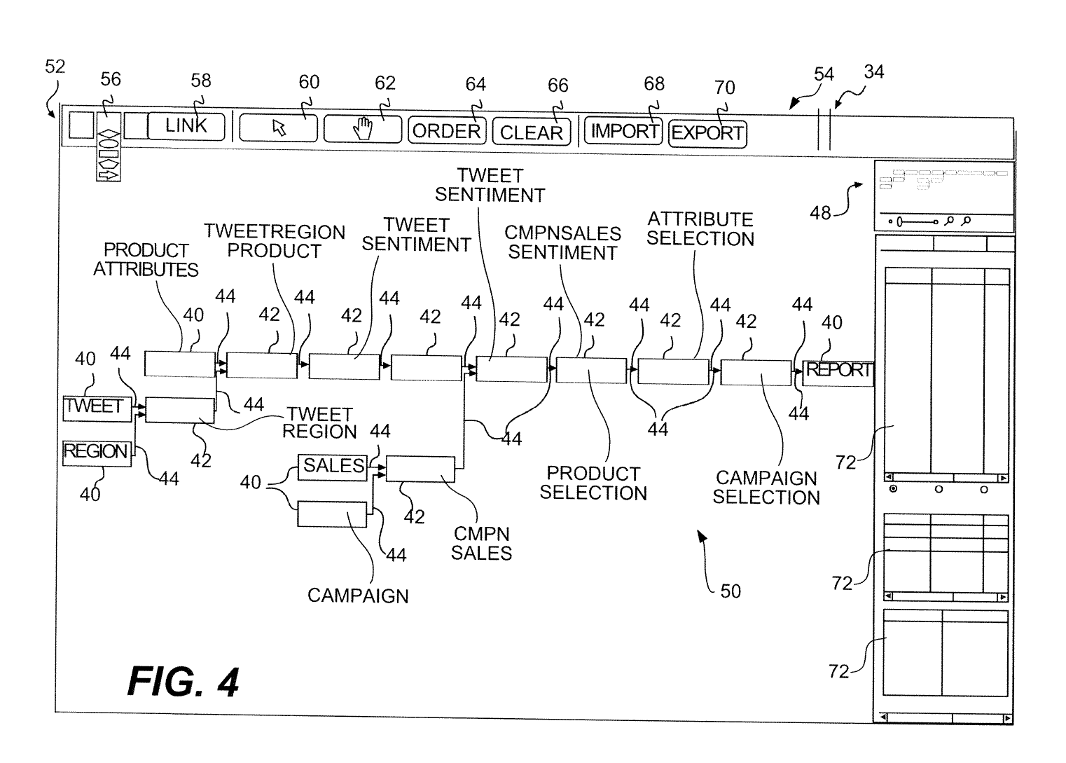

FIG. 3 illustrates another exemplary system 12 used to create an exemplary data-flow 20. The data-flow editor 30 includes the graphical user interface 34, and FIG. 4 shows an example of the graphical user interface 34. The GUI 34 provides a graphical representation 50 of the data-flow and includes table forms 72 illustrating metadata 36 associated with the data-flow. A user or programmer may instruct the processor 76 of the data-flow editor 30, shown in FIG. 3, to divide the graphical representation 50 of FIG. 4 into the fragments 38. The user or programmer may also identify the execution engine 22 capable of executing each of the fragments 38. The fragments 38 are executable on different execution engines 22 and each of the execution engines 22 are instructed by a different execution code language. The processor 76 of the data-flow editor 30 creates in-memory data structures 74 representing each data store and operator of the data-flow. The in-memory data structures 74 store an internal representation of the data flow and its metadata. The data-flow editor includes a compiler 88 that takes the internal representation and generates the first code language representing the fragments 38 of the data-flow 20 and the metadata 36 associated with the data-flow 20. The metadata 36 includes the names of the execution engines 22 identified by the user and other metadata, such as the metadata listed in the table forms 72 in FIG. 4 associated to the nodes and arcs. For each fragment 38, the data-flow translator 32 translates the first code language into the execution code language instructing the corresponding execution engine 22.

Referring again to FIG. 3, the data-flow 20 includes at least two data stores 24, and typically multiple data stores 24. At least one of the data stores 24 is a data source that obtains, provides, or contains data to be processed. Examples of data sources include a stream or feed of a social media platform, a file containing records, or a source database table. Also, at least one data store 24 of the data-flow 20 is a data target containing the processed data.

The operators 26 of the data-flow 20 shown in FIG. 3 process or perform functions on the data provided by the data sources. The data-flow 20 includes at least one operator 26, but typically several operators 26. The operators 26 of the data-flow 20 may include generic operations, such as a filter operation, a join operation, or a grouping operation. The operators 26 may alternatively or additional include user defined operations, such as a sentiment analysis operation. The connections 28 are disposed between the, operators 26, and combinations of the data stores 24 and the operators 26. If the connection 28 is between two operators 26, the output of one operator 26 is the input of the other. If the connection 28 is between a data store 24 and an operator 26, the output of the data store 24 is the input of the operator 26, or vice versa.

Each of the data stores 24 and operators 26 may use a particular execution engine 22 for execution, for example one of the two execution engines 22 shown in FIG. 3. The execution engines 22 may be employed to execute the data-flow 20, and each of the executions engines 22 may be instructed by a different execution code language. At least two of the operators 26, employ different execution engines 22, which are instructed by different execution code languages. The data-flow 20 is typically divided into the fragments 38, wherein each fragment 38 includes zero, one or several data stores 24 and at least one operator 26, and each fragment 38 is executed by a different execution engine 22. For example, a single data-flow may use a “Vertica” execution engine, a “Postgres” execution engine, a “Hadoop” execution engine, and a “Storm” execution engine. The particular execution engine 22 used to execute each operator 26, or fragment 38 of the data-flow 20, is predetermined by the user and each execution engine 22 is identified by a name. For example, one fragment 38 of the data-flow 20 may be executed using “Pig” as the execution code language for Hadoop, and another fragment 38 of the data-flow may be executed using “Standard Query Language” or “SQL” as the execution code language for Postgres.

FIG. 3 also shows that each of the data stores 24 and each of the operators 26 have associated metadata 36. The form tables 72 of FIG. 4 show some examples of the associated metadata 36. At least a portion of the associated metadata 36 is employed or required to access the corresponding data store 24 and execute the corresponding operator 26. The metadata 36 includes particular kinds of metadata 36, for example, one kind of metadata 36 provided for each data store 24 and operator 26 is the name of the associated execution engine 22. Other kinds of metadata are the inputs and outputs of each operator or the condition for a filter operation. A filter operation is one example of an operator 26 build in the data-flow editor 30. Input data to this operator 26 is filtered according to a condition or expression specified by the user when editing the operator 26 in the data-flow 20. For example, if the input data is tweets, the user could filter the tweets according to their timestamp so that only those corresponding to a given day would pass along the remainder of the data-flow 20.

In addition to the in-memory data structures 74 of FIG. 3 used to store the data-flow layout, the data stores and the associated metadata typically provided for each of the data stores, the data-flow editor 30 includes a memory 46 to store a list of operators and the associated metadata that the user will have to provide for each of the operators.

An embodiment of a method used to create or edit the data-flow 20 of FIG. 3 includes prompting the user to provide the metadata typically provided for data stores and operators. storing the metadata provided for the data stores and the operators in the in-memory data structures 74 The method may also include automatically obtaining at least a portion of the metadata for one of the data stores or operators of the data-flow.

The associated metadata provided for the data stores oftentimes includes schemas, which include attributes or fields and their types. Properties which may include delimiters, headers, filenames, filetypes and connection or location information. The operators metadata may include a name, type, operation type (opType), engine, input and output schemas and parameters. Examples of node names, types, opTypes, schemas, and attributes of a schema are shown on the graphical user interface 34 of FIG. 4.

An illustration of the entire data-flow and the associated metadata 36 may be displayed on the graphical user interface 34 of FIG. 4. The visual display allows the programmer or other end user to conveniently create the entire data-flow and enter metadata 36 associated with the data-flow. The graphical user interface 34 includes several sections. A first one of the sections is a thumbnail 48 including a graphical representation 50 of the entire data-flow.

A second one of the sections of the graphical user interface 34 includes a canvas 52 containing at least a portion of the graphical representation 50 of the data-flow available for editing. In the graphical representation 50, the data stores and operators are illustrated as the nodes 40, 42, either a store node 40 or an operator node 42. The connections between the data stores and operators are illustrated as the arcs 44 between the corresponding nodes 40, 42. The arcs 44 indicate the inputs and outputs of each of the data stores and operators and establish an order of execution of the data stores and operators of the data-flow.

The graphical representation 50 on the canvas 52 is larger than the graphical representation 50 of the thumbnail 48 and can be zoomed in and out as needed The user may provide, create, or edit the data-flow by providing, creating, or editing the portion of the graphical representation 50 contained on the canvas 52.

FIG. 4 further illustrates that a third section of the graphical user interface 34 is a toolbar 54 including several icons 56, 58, 60, 62, 64, 66, 68, 70 representing functions or tools that allow the programmer or user to create and edit the portion of the data-flow represented by the graphical representation 50 contained on the canvas 52. The graphical user interface 34 automatically updates the graphical representation 50 of the thumbnail 48 when any changes are made to the graphical representation 50 on the canvas 52.

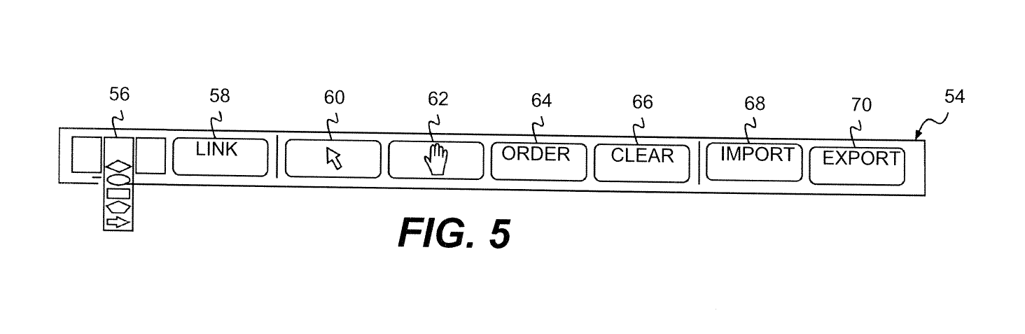

FIG. 5 is an enlarged view of the toolbar 54 shown in FIG. 4 according to one embodiment. The toolbar 54 includes a nodes icon 56 representing a function allowing the programmer or end user to create a new data store or new operator in the data-flow. The programmer or end user does so by selecting the nodes icon 56 and specifying whether a new store node 40 or operator node 42 should be created on the canvas 52 of the graphical user interface 34 of FIG. 4. The processor 76 of FIG. 3 creates the corresponding new data store or operator in the data-flow and displays the new node 40, 42 corresponding to the new data store or operator on the canvas 52 and in the thumbnail 48.

The toolbar 54 also includes at least one arc icon 58 representing a function allowing the user to create a new connection between data stores and the operators. The programmer or end user does so by selecting the arc icon 58 and placing a new arc 44 between two nodes 40, 42 on the graphical user interface 34 of FIG. 4, corresponding to the two data stores or operators to be connected. The processor 76 of FIG. 3 creates the new connection in the data-flow and displays the new arc 44 corresponding to the new connection on the canvas 52 and in the thumbnail 48 of FIG. 4.

The toolbar 54 includes an arrow icon 60 representing a function allowing the user to select at least one data store, operator, or portion of the data-flow to be edited, or at least one data store or operator for which metadata should to be provided. The programmer or end user does so by selecting the arrow icon 60 and highlighting the nodes 40, 42 on the canvas 52 of FIG. 4 that correspond to the data stores or operators for which metadata should be provided.

The toolbar 54 may include a hand icon 62 representing a function allowing a user to move at least one data store or operator relative to other data stores or operators. The hand icon 62 also represents a function allowing a user to rubberband and move at least two interconnected operators, or a combination of the data stores and the operators to a new location. The programmer or end user does so by selecting the hand icon 62, highlighting, and dragging the nodes 40, 42 on the canvas 52 of FIG. 4 that correspond to the data stores or operators.

The toolbar 54 may include an order icon 64 representing a function allowing a user to arrange the layout of the data-flow, that is, positioning the nodes 40, 42 representing the data stores and operators in a predetermined location relative to one another on the canvas 52 of FIG. 4 in such a way that the data-flow looks more organized. Once the programmer or user selects the order icon 64, the processor 76 of FIG. 3 automatically re-arranges the nodes 40, 42 on the canvas 52 to a predetermined location. For example, each of the nodes 40, 42 may be aligned horizontally and vertically relative to the adjacent node 40, 42.

The toolbar 54 may include a clear icon 66 representing a function allowing a user to delete one of the data stores or operators of the data-flow. The programmer or end user does so by selecting the hand icon 62 and highlighting the nodes 40, 42 on the canvas 52 corresponding to the data stores or operators to be deleted and then selecting the clear icon.

The toolbar 54 may include an import icon 68 representing a function allowing a user to import a data-flow and associated metadata from a file or other source into the data-flow editor. The programmer or user does no by selecting the import icon 68 and identifying the file or source containing the data-flow and metadata. The toolbar 54 also typically includes an export icon 70 representing a function allowing a user to save the data-flow and the associated metadata to a file or other source. The programmer or user does so by selecting the export icon 70 and identifying the file or other location where the data-flow and metadata should be saved. Once the user selects the export icon 70, the processor 76 of FIG. 3 may automatically remove the corresponding nodes 40, 42 and metadata from the graphical user interface 34.

Referring back to FIG. 4, a fourth section of the graphical user interface 34 may include the table forms 72, or charts 72, adjacent the canvas 52 listing the metadata associated with each of the data stores and operators represented by the nodes 40, 42 of the graphical representation 50. The data-flow editor 30 of FIG. 3 includes a function allowing the programmer or user to enter the metadata associated with each of the data stores and operators into the charts 72 by selecting the corresponding nodes 40, 42 on the canvas 52 using the arrow icon 60 shown in FIG. 5. The metadata listed in the charts 72 at least includes the name of the execution engine employed to access each data store and to create execution code for each operator.

When a user creates a data store or operator, the processor 76 may provide or create some of the metadata 72 automatically based on the type of data store or operator, or based on other information provided by the user. In one embodiment, such as the embodiment shown in FIG. 3, the system 12 stores this metadata in the in-memory data structures 74 of the data-flow editor 30 and the metadata is automatically listed in the table form 72 on the graphical user interface 34 of FIG. 4.

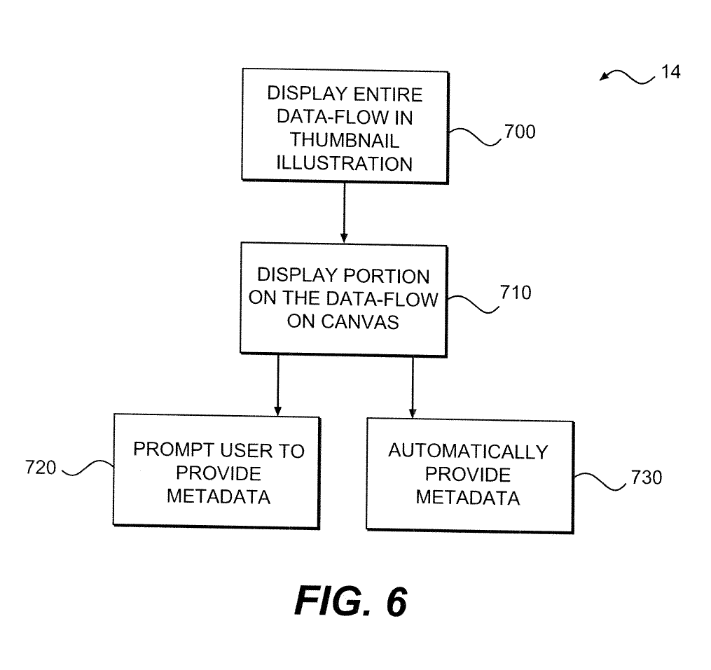

FIG. 6 illustrates a method 14 of providing the illustration on the graphical user interface 34 of FIG. 4, according to one embodiment. The method 14 includes displaying the entire data-flow in the thumbnail (block 700) and displaying at least a portion of the data-flow on the canvas (block 710); prompting the user to provide the metadata associated with the portion of the data-flow displayed on the canvas (block 720); and automatically providing a portion of the metadata associated with the data-flow using information previously provided by the user (block 730) or automatically produced by the data-flow editor such as the inputs to an operator from the outputs of the preceding operator. The user can modify the automatic propagation of outputs of an operator as inputs to the next operator for example by deleting the corresponding arrow or changing the name of the input. The method 14 can be implemented by the processor 76 of FIG. 3.

Further, the processor 76 of FIG. 3 may automatically list the type or kind of metadata that should be provided for one or more of the data stores or operators listed in the chart 72 of FIG. 4. Since the memory 46 of the data-flow editor 30 stores a list of operators and the metadata typically provided and employed to access and execute the data stores and operators, respectively, the processor 76 of FIG. 3 may retrieve that information and automatically list the kind of metadata that should be provided in the chart 72 of FIG. 4.

The GUI 34 of FIG. 3 may also prompt the user to enter the metadata employed by the execution engines 22 to execute the data-flow 20. This prompt may be provided simply by labeling the chart 72 of FIG. 4 “Metadata” or otherwise indicating that the metadata associated with the data stores and operators should be provided on the graphical user interface 34. The GUI 34 of FIG. 3 typically prompts the programmer or user to enter the name of the execution engine 22 for each of the data stores 24 and operators 26, if the engine name is not already provided. This may be done by including a field in the chart 72 of FIG. 4 titled “Engine.” The metadata is typically typed into the chart 72 on the graphical user interface 34 by the user in response to the prompt.

The type of metadata employed to execute the data-flow that should be provided to the data-flow editor varies depending on the type of data store or operator. The prompt provided by the GUI of the data-flow editor may also vary depending on the type of data store or operator. If the data store is a source database table, the processor of the data-flow editor automatically retrieves the table metadata from a catalog of the database indicated by the user with the connection information. The GUI then prompts the user to identify the metadata that is relevant for the data-flow, for example, the attributes, and their data types, to be used by subsequent operators and that should be listed in the metadata chart. If the data store is a file containing records, the data-flow editor is provided with the file name and location. The processor of the data-flow editor then automatically retrieves and displays a sample of the records on the canvas 52 of FIG. 4 and the GUI prompts the user to identify the fields (and their data types) that are relevant to the data-flow and are to be listed as the data store metadata in the chart 72.

The programmer or user may identify the execution engine employed to execute each of the data stores and operators and may enter the corresponding execution engine as metadata. This may be done by dividing the graphical illustration of the data-flow illustrated on the graphical user interface into the fragments, each including at least one data store, operator, or a combination of the data stores and the operators. The data stores and operators of one fragment are respectively accessed or executed by the same execution engine. However, each fragment of the data-flow can be executed by a different execution engine, and the different execution engines are instructed by different execution code languages.

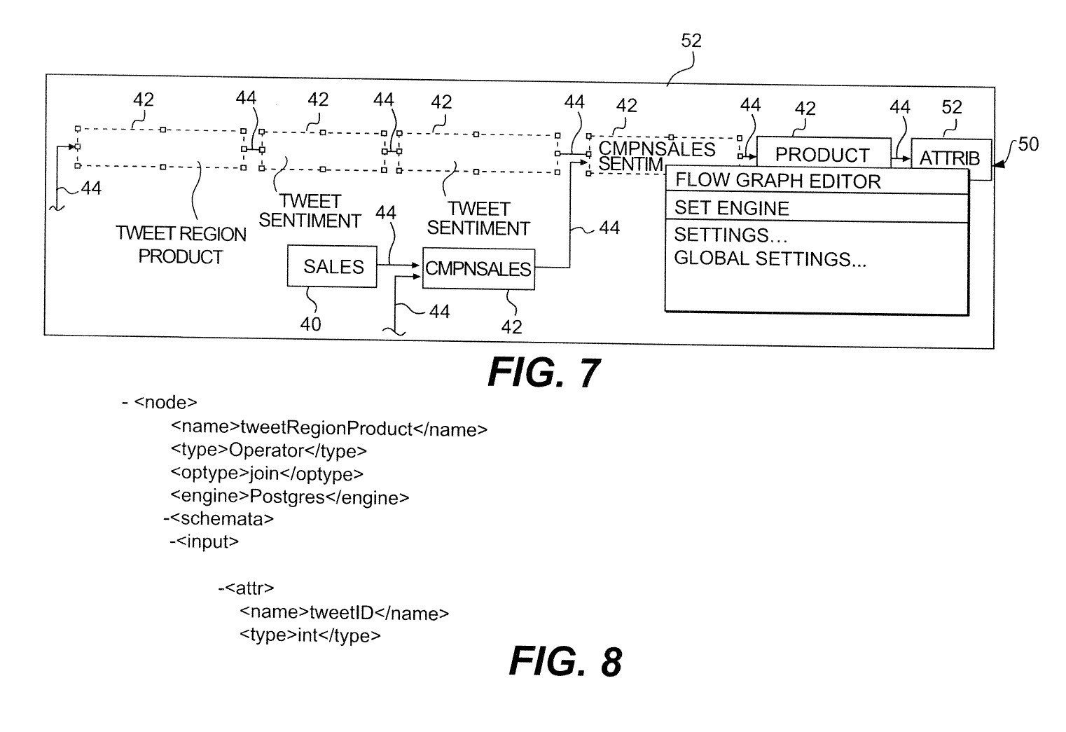

The programmer may use the graphical user interface to identify the fragments. The arrow icon may be used to select nodes on the canvas representing data stores and operators having the same execution engine by rubberbanding the section containing them. FIG. 7 illustrates one embodiment, wherein a group of nodes 40, 42 and arcs 44 has been rubberbanded, and a pop-up window is displayed prompting the user to enter the name of the execution engine used to execute the nodes 40, 42 and arcs 44. The programmer may type the name of the execution engine into the pop-up window, or select the name of the execution engine from a list in the pop-up window. The name of the execution engine provided is automatically added to the metadata chart 72 of FIG. 4. The specific execution engine used to execute each data store or operator is predetermined by the user.

Referring back to FIG. 3, the processor 76 of the data-flow editor 30 creates the in-memory data structures 74 to store an internal object representation of each of the nodes 40, 42 and arcs 44 representing the data-flow 20 and representing the associated metadata 36, including the metadata 36 employed or required by the execution engines 22. The processor 76 of the data-flow editor 30 also converts the internal object representation to a first code language representing the data-flow 20 and the associated metadata 36, including the metadata 36 required by the execution engines 22. In one embodiment, the first code language is an Extensible Markup Language (XML), but other code languages may be used. For example, the XML language may include tags corresponding to the associated metadata 36 of each data store 24 and operator 26, wherein one of the tags is an engine tag indicating the execution engine 22 used to access or execute the data store 24 or operator 26. FIG. 8 includes an example of a portion of the first code language, wherein the first code language is XML. The first code language may be written by the processor 76 of the data-flow editor 30 of FIG. 3.

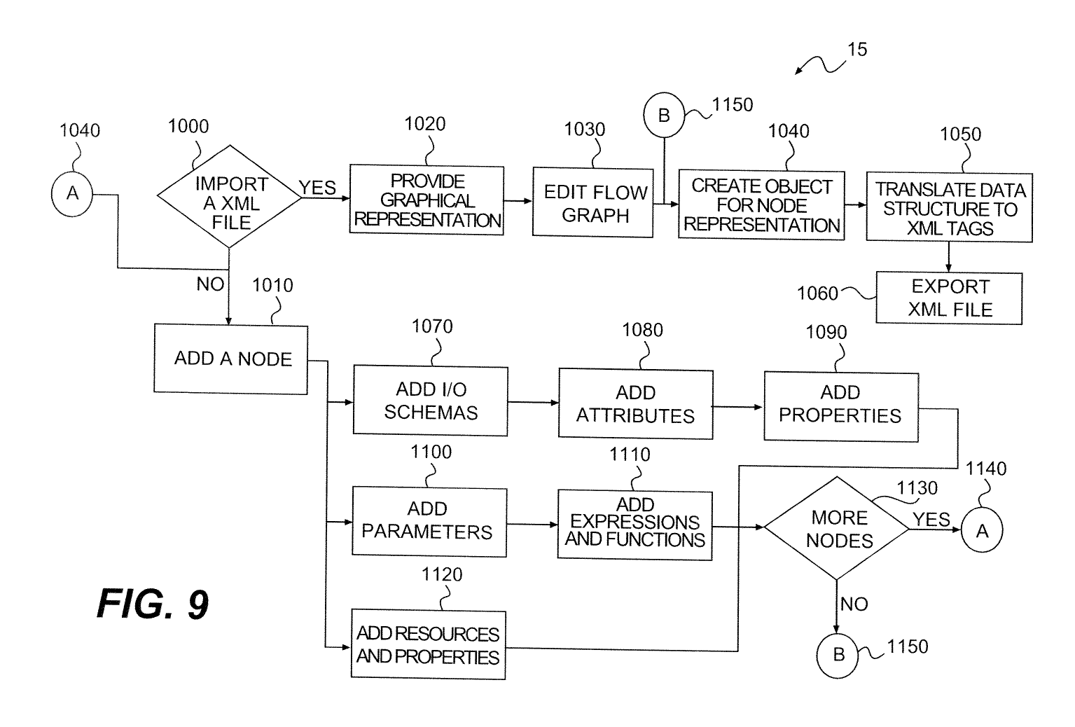

FIG. 9 illustrates an embodiment of a method 15 of creating a first code language representation of a data-flow from the internal object representation stored in the in-memory data structures, prior to transmitting the data-flow to the data-flow translator 32. The method 15 first includes importing a data-flow to be edited from a file or creating the data-flow from scratch.

If the data-flow is imported from the file, (block 1000) then the data-flow is already represented by a first code language. In this case, the method 15 includes providing the graphical representation of the data-flow in the GUI (block 1020). The processor 76 of FIG. 3 may provide the graphical representation based on the first code language of the file. The method 15 next includes editing the graphical representation on the GUI (block 1030). Once the graphical representation of the data-flow is edited, the method 15 includes creating an object representation of the data-flow (block 1040), translating the object representation to a first code language (block 1050), and exporting a file containing the first code language to the data-flow editor (block 1060). If the first code language is XML, then the first code language typically includes tags for each of the nodes and arcs and tags for the metadata, for example there may be an engine tag for each node to describe the execution engine corresponding to the node.

If the data-flow is created from scratch by the user, then the method 15 first includes adding a node that represents a data store or operator (block 1010). The method 15 next includes adding metadata corresponding to the data store or operator (blocks 1070-1120). The metadata can include, for example, schemas, parameters, attributes, properties, parameters, expressions, functions, and resources. The method 15 next includes either adding more nodes (block 1140) or proceeding to translate the data-flow to the first language representation (block 1150). As the data-flow is created, the metadata about its data stores and operators is captured by the data-flow editor and stored as an internal object representation in the in-memory data structures. If the user decides to add more nodes (block 1140), then blocks 1010 and 1070-1120 are repeated. If the user decides the data-flow is complete (block 1150), then the method 15 proceeds to blocks 1040-1060.

Referring back to FIGS. 1-3, the first code language representing the data-flow 20 is transmitted from the data-flow editor 30 to the data-flow translator 32. For each fragment 38, the data-flow translator 32 translates the first code language into the execution code language employed by the execution engine 22 executing that particular fragment 38 (block 230 of FIG. 2). The data-flow processor 76 first represents the fragments 38 of the data-flow 20 by the first code language, and then translates the fragments 38 such that each of the fragments 38 are next represented by a different execution code language. For example, if one fragment 38 of the data-flow 20 is executed by an engine instructed by “Hadoop” and another fragment 38 of the data-flow 20 is executed by an engine instructed by “Vertica,” then the portion of the first code language representing the first fragment 38 is translated from the XML language to a Hadoop language such as Pig and the first code language representing the second fragment 38 is translated from the XML language to SQL.

As shown in FIG. 3, the data-flow translator 32 includes multiple engine-specific translators 78 that translate the first code language to the execution code languages of each of the required execution engines 22. Two engine-specific translators 78 are shown in FIG. 3, but more may be employed. A separate engine-specific translator 78 is provided for each execution engine 22. Accordingly, block 230 of FIG. 2 includes translating the first code language of each of the fragments 38 to the execution code language of the corresponding execution engine 22 independently.

Referring again to FIG. 3, the data-flow translator 32 typically includes a main processor 80 which receives the data-flow 20 from the data-flow editor 30 and separates the first code language into multiple pieces based on the fragments 38 of the data-flow 20. The main processor 80 then sends the pieces of the first code language to the corresponding engine-specific translator 78. There is an engine-specific translator 78 corresponding to each execution engine 22 employed to execute the data-flow 20. If the first code language is XML, the main processor 80 may separate the first code language into sections based on the engine tags of the nodes.

Each of the engine specific translators 78 of FIG. 3 includes an engine-specific processor 82 that reads the piece of first code language representing the fragment 38 of the data-flow 20 and the associated metadata 36. The engine-specific processor 82 also includes a specific memory 84 that stores the first code language. In one embodiment, when the XML language is used, the engine-specific processor 82 first reads the nodes representing the data stores 24 and operators 26 and the associated metadata 36 of the data stores 24 and operators 26 from the first code language. Next, the engine-specific processor 82 reads the arcs between the nodes 40, 42 representing the connections 28 between the data stores 24 and operators 26. The engine-specific processors 82 may sort the nodes based on the order of the nodes and the arcs. This order represents the order of execution of the operators 26 of the data-flow 20. The order also indicates the order in which the data is transmitted through the data-flow 20. The engine-specific processor 82 then adds the sorted nodes representing the data stores 24 and operators 26 to a sorted nodes list in the memory 46.

Once the nodes of the first code language are sorted, the engine-specific processor 82 of FIG. 3 translates the first code language into a statement expressed in the execution code language of the corresponding execution engine 22. The first code language is translated according to the order of the sorted nodes list. For example, if a store node is listed before an operator node, the first code language representing the store node will be translated (into code to access the data store) before the first code language representing the operator node. The first code language representing each store node and each operator node is translated independent of the other nodes.

The engine-specific translators 78 of the data-flow translator 32 shown in FIG. 3 provide the statements in the execution code languages required by the multiple execution engines 22. The data-flow translator 32 writes the statements to an output file 86, and the output file 86 is provided to the execution engines 22.

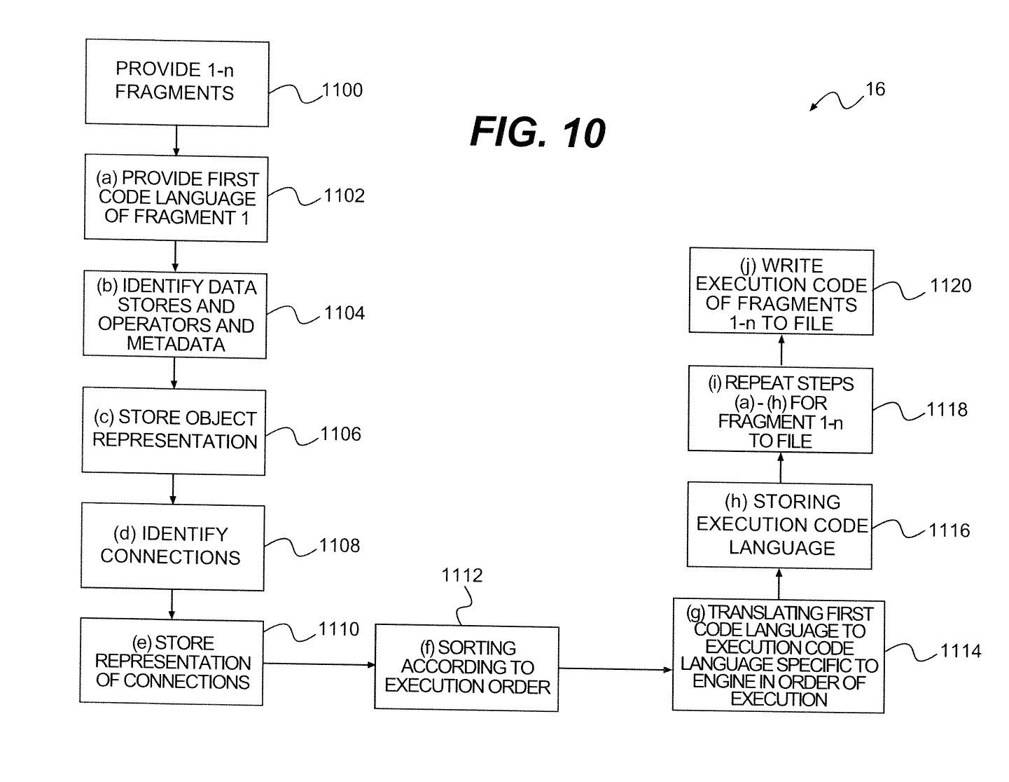

FIG. 10 illustrates an embodiment of a method 16 associated with the data-flow translator 32 of FIG. 3. The method 16 of FIG. 10 is performed after the data-flow editor 30 of FIG. 3 provides the first code language. The method 16 first includes providing the fragments, wherein n represents the number of fragments (block 1100). The method 16 next includes providing the first code language for one of the fragments of the data-flow to the data-flow translator (block 1102); identifying the data stores and the operators in the fragment (block 1104); and identifying the associated metadata of the identified data stores and the identified operators (block 1104). The method 16 next includes storing a representation of the data stores and operators and the associated metadata of the fragment (block 1106), for example as an object representation. The method 16 next includes identifying connections between the data stores and operators of the fragment after storing the representation of the data stores and operators (block 1108); and storing a representation of the connections of the fragment (block 1110). Next, the method includes sorting the data stores and operators of the fragment according to order of execution based on the connections and the associated metadata (block 1112); translating the first code language of each of the data stores and each of the operators to the execution code language independently and in the order of execution (block 1114); and storing the execution code language of the data stores and the operators on the list in the order of execution (block 1116). Block 1118 indicates that blocks 1102-1116 are repeated for each of the fragments of the data-flow. After blocks 1102-1116 are performed on each fragment of the data-flow, the method 16 includes writing the list of execution code language for each of the fragments of the data-flow to the file for execution by the execution engines (block 1120).

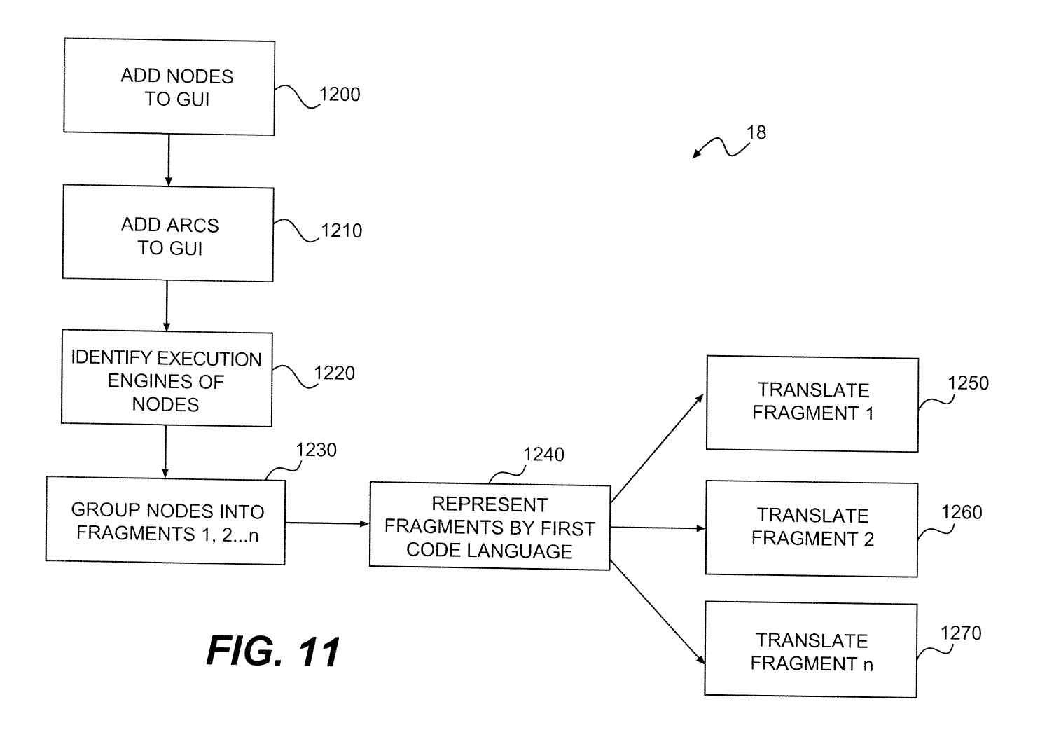

FIG. 11 illustrates an embodiment of a method 18 that creates a data-flow to be executed by multiple engines. The method 18 may be implemented by the data-flow editor 30 and data-flow translator 32 of the system 12 of FIG. 3. The method 18 may also be stored on a computer readable medium. The method 18 includes prompting a user to provide a data-flow including data stores, operators, and connections between the data stores and operators by adding nodes representing the data stores and the operators to a GUI (block 1200) and by adding arcs between the nodes representing connections between the corresponding data stores and operators to the GUI (block 1210) and prompting the user to identify the nodes on the GUI which represent the data stores and the operators executable by the same execution engine (block 1220). The method 18 further includes grouping the identified nodes executable by the same execution engine into a fragment (block 1230); representing each of the fragments by a first code language (block 1240); and independently translating the first code language of each fragment into an execution code language instructing the corresponding execution engine (blocks 1250-1270).

We claim:

1. A system, implemented on a suitably programmed device, that provides a data-flow employing multiple execution engines, comprising:
a data-flow editor including a graphical user interface (GUI) displaying the data-flow and metadata associated with the data-flow;
the data-flow editor including a processor that divides the data-flow illustrated on the GUI into fragments, wherein each fragment is executable by a different execution engine, the execution engines are identified by a user, and each of the execution engines are instructed by a different execution code language;
the processor of the data-flow editor including a compiler that provides a first code language representing the fragments of the data-flow and the metadata associated with the data-flow, wherein the metadata includes the execution engine identified by the user for each of the fragments; and
a data-flow translator that translates the first code language into the execution code language instructing the corresponding execution engine for each of the fragments.

2. The system of claim 1 wherein the data-flow includes at least one data store, at least one operator, and at least one connection between the data stores, the operators, or a combination of the data stores and the operators, the data stores and operators each having associated metadata;
the illustration of the data-flow provided on the graphical user interface includes a graphical representation of the data-flow, wherein the data stores and the operators are illustrated as nodes and the connections are illustrated as arcs between the nodes; and
the illustration of the metadata on the graphical user interface includes a table form listing the associated metadata of each data store and operator.

3. The system of claim 2 wherein the graphical user interface comprises a thumbnail including the graphical representation of the data-flow and a canvas containing at least a portion of the graphical representation available for editing.

4. The system of claim 3 wherein the graphical user interface includes a toolbar adjacent the canvas and the toolbar includes a plurality of icons representing functions.

5. The system of claim 4 wherein the toolbar includes a nodes icon representing a function that adds a data store or an operator to the data-flow and an arc icon representing a function that adds a connection between at least two of the data stores, the operators, or a combination of the data stores and the operators.

6. The system of claim 1 wherein the data-flow includes at least one data store, at least one operator and connections between them each having associated metadata and the data-flow editor includes in-memory data structures that store an internal object representation of the data stores, operators, connections and associated metadata.

7. The system of claim 1 wherein the data-flow translator includes a plurality of engine-specific translators each translating the first code language of one of the fragments to the execution code language of the corresponding execution engine.

8. A method for creating a data-flow that employs multiple engines for execution, comprising:
displaying a data-flow and metadata associated with the data-flow on a graphical user interface;
representing the data-flow and the metadata by a first code language;
dividing the data-flow illustrated on the graphical user interface into fragments, wherein each of the fragments is executable on a different execution engine and each of the different execution engines is supported by one or more different execution code languages; and
translating the first code language into an execution code language of the execution engine corresponding to each of the fragments.

9. The method of claim 8 wherein the step of providing the illustration includes displaying the entire data-flow as a graphical illustration in a thumbnail and displaying at least a portion of the graphical illustration of the data-flow on a canvas; prompting a user to provide the metadata associated with the portion of the data-flow displayed on the canvas; and automatically providing a portion of the metadata associated with the data-flow.

10. The method of claim 8 including storing a list of metadata typically provided for data stores and operators, and prompting a user to provide the metadata typically provided if the data-flow includes any data stores or operators.

11. The method of claim 8 including storing a list of metadata typically provided for data stores and operators, and automatically obtaining at least a portion of the metadata for a data store or operator of the data-flow.

12. The method of claim 8 including prompting the user to provide the metadata employed by the execution engines that execute the data-flow.

13. The method of claim 8 including creating an object representation of the data-flow and the metadata associated with the data-flow and wherein the step of providing the first code language includes translating the object representation to the first code language, and translating the first code language of each of the fragments to the execution code language of the corresponding execution engine independently.

14. The method of claim 8 wherein the step of translating the first code language into the execution code language further comprises:
(a) providing the first code language for one of the fragments of the data-flow;
(b) identifying data stores and operators in the fragment of the data-flow;
(c) identifying the associated metadata of the identified data stores and the identified operators;
(d) storing a representation of the data stores and operators and the associated metadata of the fragment;
(e) identifying connections between the data stores and operators of the fragment after storing the representation of the data stores and operators;
(f) storing a representation of the connections of the fragment;
(g) sorting the data stores and operators of the fragment according to order of execution based on the connections and the associated metadata;
(h) translating the first code language of each of the data stores and each of the operators to the execution code language independently and in the order of execution;
(i) storing the execution code language of the data stores and the operators on a list in the order of execution;
(j) repeating (a)-(i) for each of the fragments of the data-flow; and
(k) writing the lists of execution code language for each of the fragments of the data-flow to a file that is executed by the execution engines.

15. A computer readable medium storing instructions for performing a method that provides a data-flow employing multiple engines for execution, the instructions causing the computer to:
prompt a user to provide a data-flow including data stores, operators, and connections between the data stores and the operators by adding nodes representing the data stores and the operators to a graphical user interface (GUI) and by adding arcs between the nodes representing connections between the corresponding data stores and operators to the GUI;
prompt the user to identify the nodes on the GUI which represent the data stores and the operators executable by the same execution engine;
group the identified nodes executable by the same execution engine into a fragment;
represent each of the fragments by a first code language; and
independently translate the first code language of each fragment into an execution code language instructing the corresponding execution engine.
